(19) United States
(12) Patent Application Publication
(10) Pub. No.: US 2011/0285878 A1
(43) Pub. Date: Nov. 24, 2011

(54) METHOD FOR GENERATING MULTIMEDIA DATA TO BE DISPLAYED ON DISPLAY APPARATUS AND ASSOCIATED MULTIMEDIA PLAYER

(76) Inventor: Yunshu Zhang, Anhui (CN)

(21) Appl. No.: 12/808,183

(22) PCT Filed: May 24, 2010
(86) PCT No.: PCT/CN2010/073114

§ 371 Date: Jun. 15, 2010

(51) Int. Cl. H04N 5/262; H04N 7/00

(52) U.S. Cl. 348/240.99; 348/468; 348/E07.033; 348/E05.055

(57) ABSTRACT

A method for generating multimedia data to be displayed on a display apparatus includes: receiving subtitle data from a first data source; receiving first video data from a second data source different from the first data source; and transmitting the multimedia data comprising the subtitle data from the first data source and at least a part of the first video data from the second data source to the display apparatus, wherein the subtitle data and at least the part of first video data are displayed on the display apparatus at the same time.

### FIELD OF INVENTION

The present invention relates to a method for generating multimedia data that is to be displayed on a display apparatus, and more particularly, to a method for generating multimedia data whose subtitle data and video data are from different data sources, and an associated multimedia player.

### BACKGROUND OF THE INVENTION

Karaoke machines have long been a popular electronic device, enabling people to perform songs in the comfort of their own home. These machines take up space, however, and can be expensive. It is therefore important to provide a multimedia player having a vocal concert function that allows a user to perform songs accompanied by multimedia data.

### SUMMARY OF THE INVENTION

It is therefore an objective of the present invention to provide a method for generating multimedia data to be displayed on a display apparatus and an associated multimedia player, which can allow a user to have a solo vocal concert in their own home by using the multimedia player.

According to one embodiment of the present invention, a method for generating multimedia data to be displayed on a display apparatus comprises: receiving subtitle data from a first data source; receiving first video data from a second data source different from the first data source; and transmitting the multimedia data comprising the subtitle data from the first data source and at least a part of the first video data from the second data source to the display apparatus, wherein the subtitle data and at least the part of first video data are displayed on the display apparatus at the same time.

According to another embodiment of the present invention, a multimedia player for generating multimedia data utilized to be displayed on a display apparatus comprises a storage medium reader, an interface and a controller. The storage medium reader is utilized for reading subtitle data from a first data source. The interface is utilized for connecting to a second data source different from the first data source. The controller is coupled to the storage medium reader and the interface, and is utilized for receiving the subtitle data from the first storage medium and first video data from the second data source, and transmitting the multimedia data comprising the subtitle data from the first data source and at least a part of the first video data from the second data source to the display apparatus, wherein the subtitle data and at least the part of first video data are displayed on the display apparatus at the same time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multimedia player according to one embodiment of the present invention.

FIG. 2 is a diagram illustrating how a user can operate the multimedia player shown in FIG. 1 to have a solo vocal concert.

FIG. 3 is a diagram illustrating the controller shown in FIG. 1 determining a background part and a non-background part of the images captured by a camera.

FIG. 4 is a diagram illustrating the determined non-background part shown in FIG. 3 displayed on the display apparatus with new background data.

FIG. 5 is a diagram illustrating a man and a woman singing a duet.

FIG. 6 is a diagram illustrating the camera zooming in on an area including one microphone.

FIG. 7 is a diagram illustrating the camera zooming in on an area including two microphones.

FIG. 8 is a diagram illustrating the display apparatus displaying video data from a karaoke disc and a camera in turn.

FIG. 9 is a diagram illustrating the synchronization information of the video data from the camera and the karaoke disc.

FIG. 10 is a diagram illustrating a data flow of the multimedia player shown in FIG. 1 according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

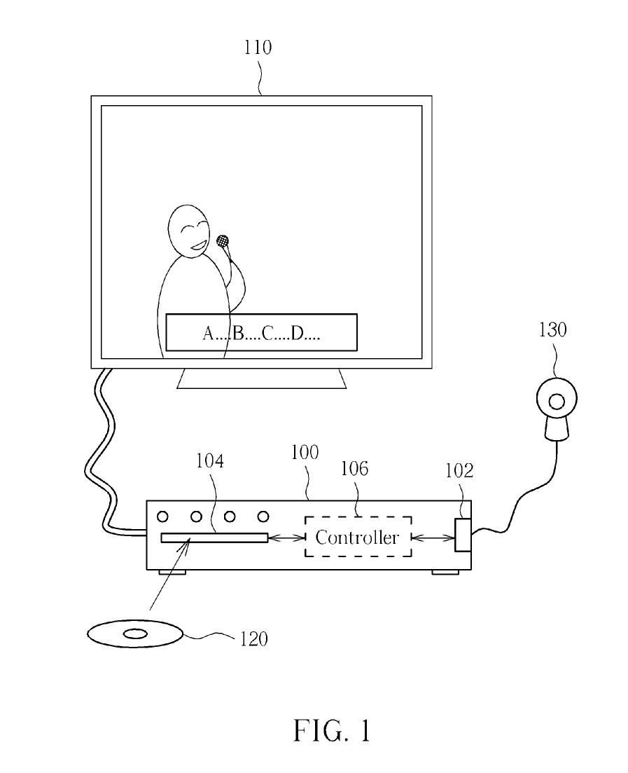

Please refer to FIG. 1. FIG. 1 is a diagram illustrating a multimedia player 100 according to one embodiment of the present invention. Referring to FIG. 1, the multimedia player 100 is coupled to a display apparatus 110, and the multimedia player 100 comprises an interface 102, a storage medium reader 104 and a controller 106, where the controller 106 can be implemented by one or more chips or chipsets. The storage medium reader 104 is used for receiving at least audio data and subtitle data from a first data source (in this embodiment, a karaoke disc 120 serves as the first data source), where the received audio data can be played by the multimedia player 100 or any other audio player, and the received subtitle data is transmitted from the storage medium reader 104 to the display apparatus 110 via the controller 106 and is displayed on the display apparatus 110. Furthermore, the controller 106 receives video data from a second data source (in this embodiment, a camera 130 serves as the second data source) via the interface 102, where the camera 130 captures images of a scene to generate the video data, and the video data is transmitted from the camera to the display apparatus 110 via the multimedia player 100 and is displayed on the display apparatus 110. In addition, the subtitle data from the karaoke disc 120 and the video data from the camera 130 are displayed on the display apparatus 110 at the same time.

It is noted that the karaoke disc 120 and the camera 130 shown in FIG. 1 are merely examples of the data sources. In other embodiments, the karaoke disc 120 can be replaced by any other data source which can provide the audio data and the subtitle data, and the camera 130 can be replaced by any other data source which can provide the video data. In addition, the video data can be transmitted from the camera 130 to the controller 106 of the multimedia player 100 via any interface. For example, the camera 130 can be connected to the multimedia player 100 via a USB (Universal Serial Bus) interface 102 and a USB transmission line, and the video data is transmitted to the multimedia player 100 via the USB interface 102 and a USB transmission line; or the video data can be transmitted from the camera 130 to the multimedia player 100 via a wireless network.

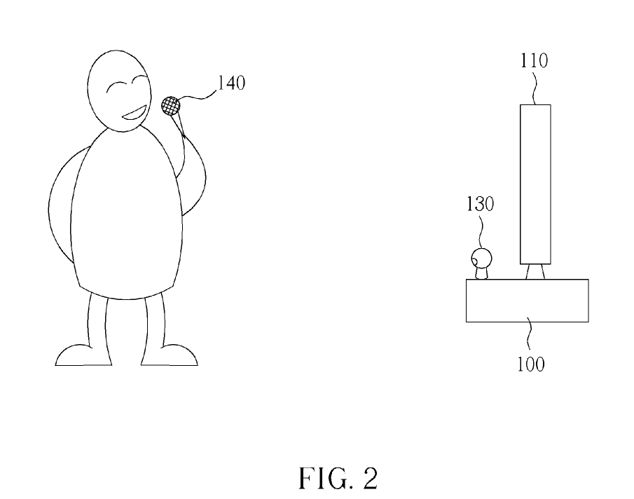

Particularly, the multimedia player 100, the camera 130 and the display apparatus 110 can be used in a room/house to provide a solo vocal concert function for a person as shown in FIG. 2. Referring to FIG. 2, a person is using a microphone 140 to sing a song, while the camera 130 captures images of the person to generate the video data, and transmits the video data to the multimedia player 100. Then, the controller 106 of the multimedia player 100 generates multimedia data which includes the subtitle data from the karaoke disc 120 and at least part of the video data from the camera 130, and transmits the multimedia data to the display apparatus 110. That is, what is displayed on the display apparatus are the subtitle data from the karaoke disc 120 and the video data from the camera 130.

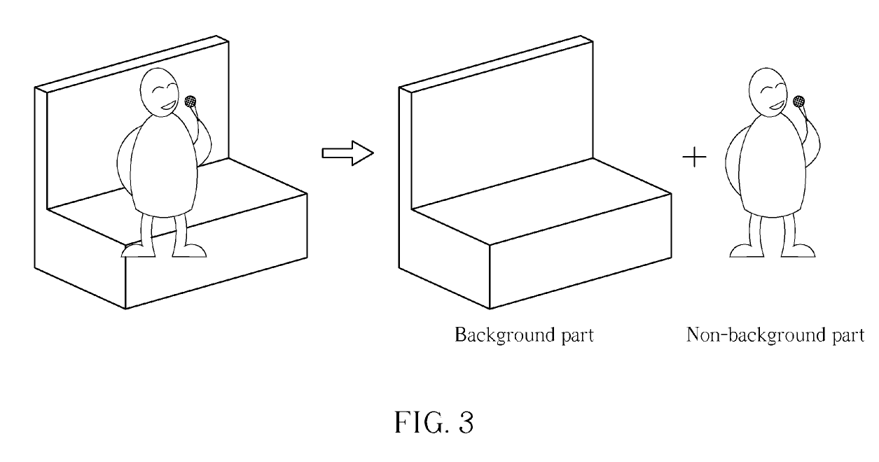

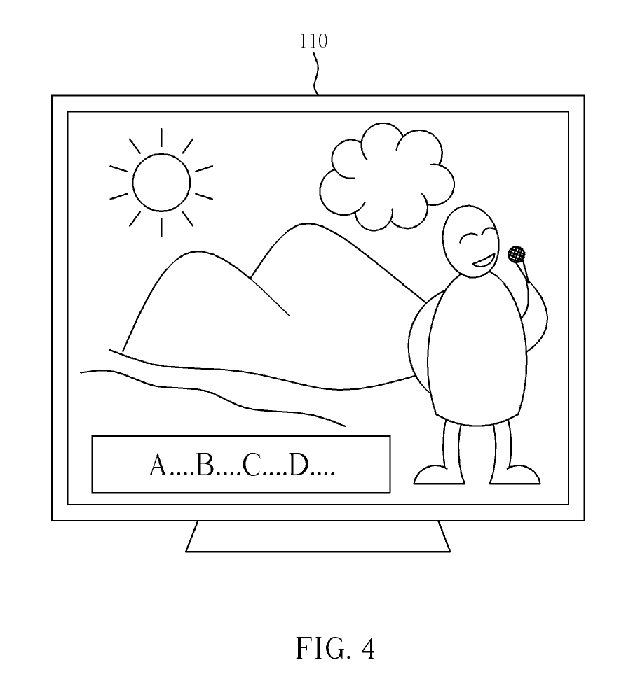

In one embodiment of the present invention, the controller 106 can determine a background part and a non-background part of the images captured by the camera 130, and the controller 106 generates the multimedia data including the non-background part of the images from the camera 130, the subtitle data from the karaoke disc 120 and new background data, and the multimedia data is transmitted to the display apparatus 100 to be displayed thereon. For further details, please refer to FIGS. 3 and 4 together. As shown in FIG. 3, the images captured by the camera 130 include a sofa and a person who is singing. The controller 106 can use a background determination algorithm to determine that the sofa is the background part of the image and the person is the non-background part of the image. Then, the controller 106 can generate the multimedia data including the non-background part of the images from the camera 130, the subtitle data from the karaoke disc 120 and new background data to the display apparatus 110, where the new background data can be from any source such as the karaoke disc 120 or any storage device connected to the multimedia player 100. As shown in FIG. 4, the display apparatus 110 displays the subtitle data from the karaoke disc 120, the person who is singing shown in FIG. 3, and the new background data.

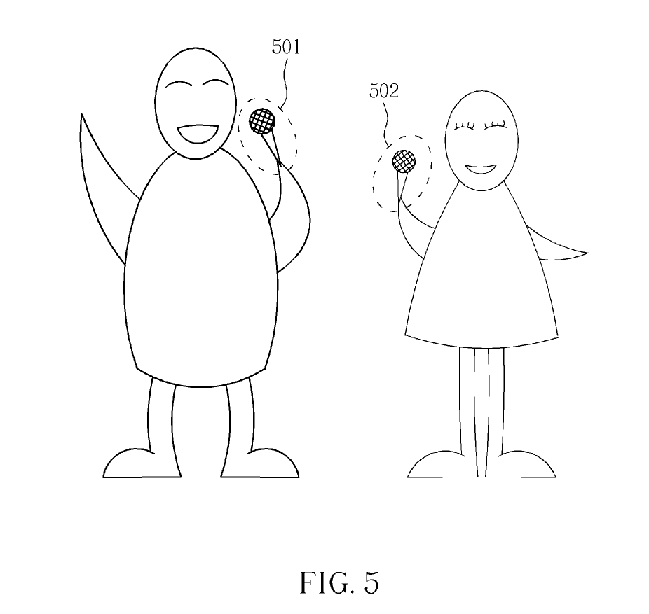

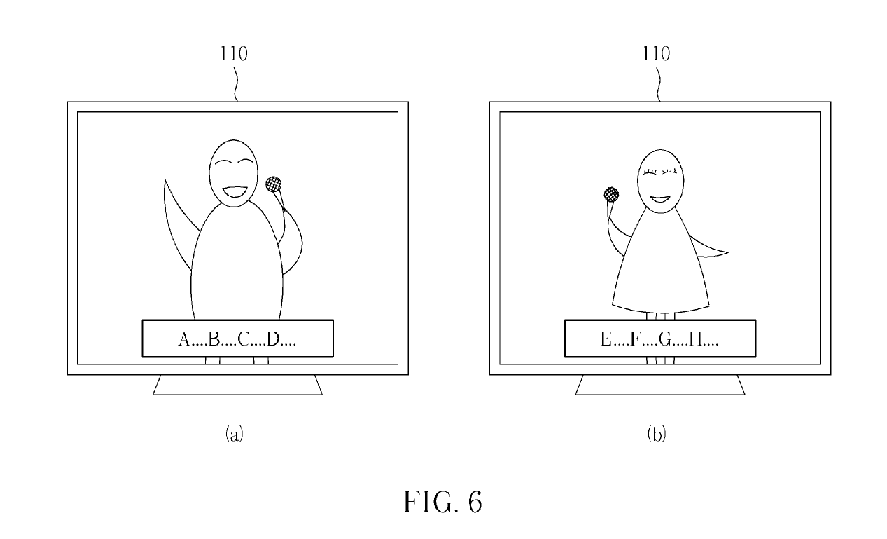

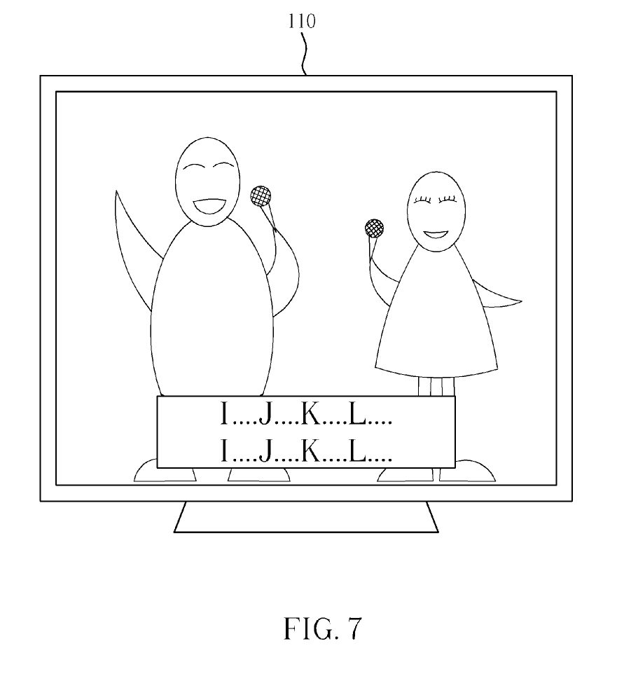

In addition, in one embodiment of the present invention, the controller 106 can detect a specific object in the scene to generate a detection result, and control the camera to zoom in on an area, including the specific object, to generate the video data according to the detection result. For further details of this operation, please refer to FIGS. 5-7. Assume that the multimedia player 100 is playing a duet, and a man and a woman use microphones 501 and 502, respectively, to sing this duet as shown in FIG. 5. The controller 106 detects the statuses of the microphones 501 and 502 to generate detection results, and the controller 106 determines whether to control the camera 130 to zoom in on the microphones 501 and/or 502 or not. For example, if the detection results indicate that only the man is singing the duet (i.e., only the microphone 501 receives a user's audio input), then the controller 106 controls the camera 130 to zoom in on an area that includes the microphone 501, to generate the video data as shown in FIG. 6(a); if the detection results indicate that only the woman is singing the duet (i.e., only the microphone 502 receives a user's audio input), then the controller 106 controls the camera 130 to zoom in on an area that includes the microphone 502, to generate the video data as shown in FIG. 6(b); in addition, if the detection results indicate that both the man and the woman are singing the duet (i.e., both the microphones 501 and 502 receive audio input), then the controller 106 controls the camera 130 to zoom in on an area that includes the microphones 501 and 502, to generate the video data as shown in FIG. 7. Furthermore, if the detection results indicate that both the microphones 501 and 502 do not receive audio input, then the controller 106 controls the camera 130 to generate the video data without zooming on the area (i.e., similar to the display apparatus in FIG. 5 or FIG. 7).

In addition, regarding the “zoom in” operation described in the above embodiment shown in FIGS. 5-7, each of the microphones 501 and 502 can be designed to have a particular shape, and the controller 106 can detect the images captured by the camera 130 to find out positions of the microphones 501 and 502 in order to control the camera to zoom in on the area including the microphone 501 and/or microphone 502. In addition, in another embodiment, each of the microphones 501 and 502 can be designed to include a transmitter, and the controller 106 receives signals from the transmitter to find out the positions of the microphones 501 and 502 to control the camera to zoom in on the area including the microphone 501 and/or microphone 502.

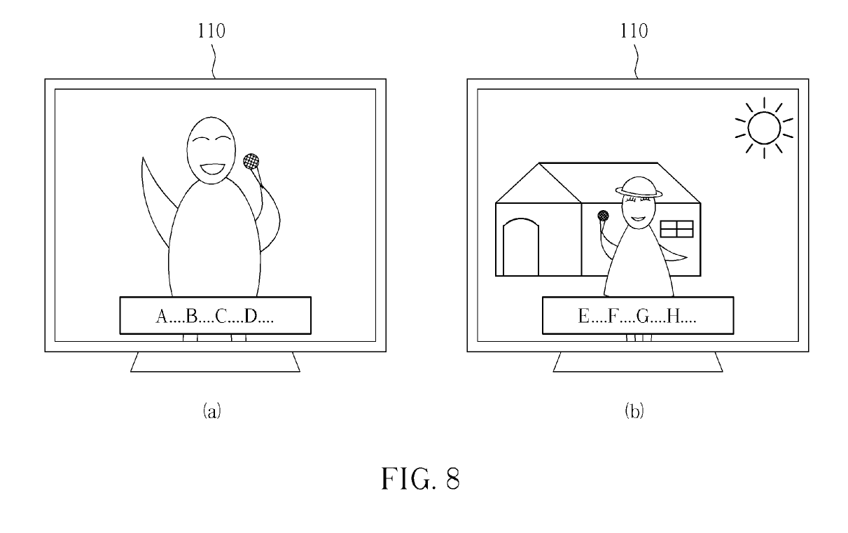

In addition, in one embodiment of the present invention, during a first period, the controller 106 generates and transmits the multimedia data comprising the subtitle data from the karaoke disc 120 and the video data from the camera 130 to the display apparatus 110; that is, the display apparatus 110 shows the video data from the camera 130 and the subtitle data from the karaoke disc 120; and during a second period adjacent to the first period, the controller 106 generates and transmits the multimedia data comprising the subtitle data and video data from the karaoke disc 120; that is, the display apparatus 110 shows the video data from the karaoke disc 120. Taking FIG. 8 as an example and assuming that the multimedia player 100 is playing a duet but only a man sings the duet, during the first period when the man sings the duet, the display apparatus 110 shows the video data generated from the camera 130; and during the second period when the duet should be sung by another person, the display apparatus 110 shows the video data from the karaoke disc 120.

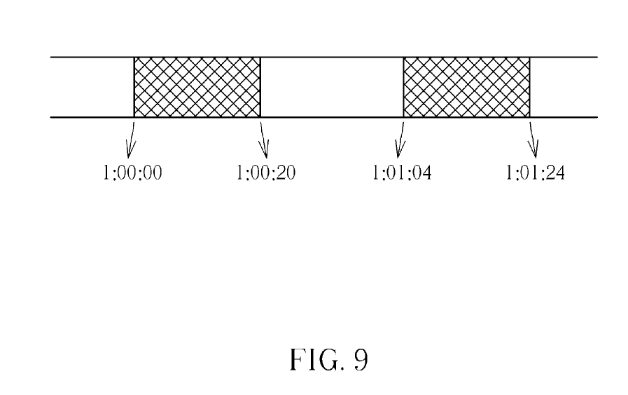

In addition, in the above-mentioned embodiment shown in FIG. 8, the controller 106 can store the video data generated from the camera 130 into a storage medium, and record synchronization information of the video data from the camera 130 and the karaoke disc 120. For further details, please refer to FIG. 9. FIG. 9 is a timing diagram illustrating the duet song shown in FIG. 8. Referring to FIGS. 8 and 9, assuming that the man sings the duet during the periods 1:00:00-1:00:20 and 1:01:04-1:01:24, then the controller 106 stores the video data (the man who is singing) generated from the camera 130 into the storage medium, and records synchronization information about how the video data stored into the storage medium corresponds to the periods 1:00:00-1:00:20 and 1:01:04-1:01:24 of the karaoke disc 120. Then, at a next time, the karaoke disc 120 and the storage medium can be read by the multimedia player 100, and during the periods 1:00:00-1:00:20 and 1:01:04-1:01:24 of the karaoke disc 120, the display apparatus 110 will show the video data stored in the storage medium (i.e., the singing man as shown in FIG. 8) and the subtitle data from the karaoke disc 120.

In addition, the karaoke disc 110 can be designed to have many special effects that can be applied to the video data from the camera 130. For example, some special video data (such as flash effect) can be added when the display apparatus 110 would like to show the video data from the camera 130, or special audio data (such as applause) can be played during the time when display apparatus 110 shows the video data from the camera 130.

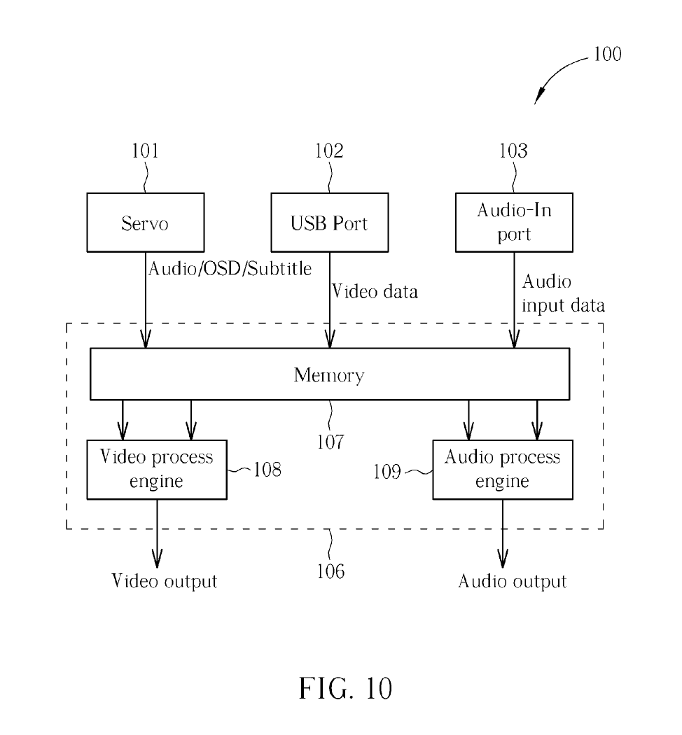

In addition, please refer to FIG. 10. FIG. 10 is a diagram illustrating data flow of the multimedia player 100 according to one embodiment of the present invention. As shown in FIG. 10, the multimedia player 100 comprises a servo 101, a USB port 102, an audio-in port 103, and the controller 106, where the controller comprises a memory 107, a video process engine 108 and an audio process engine 109. The servo 101 receives the audio/OSD (on-screen display)/subtitle data and/or video data from the karaoke disc 120 via the storage medium reader 104 shown in FIG. 1. The USB port 102 (i.e. the interface 102 shown in FIG. 1) receives the video data from the camera 130. The audio-in port 103 receives the audio input data from the microphone. Then, the data from the server 101, the USB port 102 and the audio-in port 103 are temporarily stored in the memory 106. The video process engine 108 and the audio process engine 109 respectively get the required data from the memory 107 to output the video output data and the audio output data, where the video output data and the audio output data serve as the multimedia data which is to be played or displayed on the display apparatus 110.

Briefly summarized, in the multimedia player and the method for generating the multimedia data of the present invention, the audio data and the subtitle data from the karaoke disc are played/displayed with the instantaneous video data from the camera. Therefore, the user can use the multimedia player in their own house to obtain a solo vocal concert function.

Those skilled in the art will readily observe that numerous modifications and alterations of the device and method may be made while retaining the teachings of the invention.

1. A method for generating multimedia data to be displayed on a display apparatus, comprising:
receiving subtitle data from a first data source;
receiving first video data from a second data source different from the first data source; and
transmitting the multimedia data comprising the subtitle data from the first data source and at least a part of the first video data from the second data source to the display apparatus, wherein the subtitle data and at least the part of first video data are displayed on the display apparatus at the same time.

2. The method of claim 1, wherein the second data source is a camera, and the camera captures images of a scene to generate the first video data.

3. The method of claim 2, further comprising:
determining a background part and a non-background part of the images captured by the camera;
wherein the step of transmitting the multimedia data including the subtitle data from the first data source and at least a part of the first video data from the second data source to the display apparatus comprises:
transmitting the multimedia data comprising the subtitle data from the first data source and the non-background part of the images from the camera to the display apparatus, wherein the background part of the images from the camera is not transmitted to the display apparatus.

4. The method of claim 3, wherein the step of transmitting the multimedia data including the subtitle data from the first data source and the non-background part of the images from the camera to the display apparatus comprises:
receiving background image data different from the background part of the images; and
transmitting the multimedia data comprising the subtitle data from the first data source, the non-background part of the images from the camera, and the background image data to the display apparatus.

5. The method of claim 2, further comprising:
detecting a specific object in the scene to generate a detection result; and
controlling the camera to zoom in on an area, including the specific object, to generate the first video data according to the detection result.

6. The method of claim 5, wherein the specific object is a microphone, and the step of controlling the camera to zoom in on an area that includes the specific object to generate the first video data according to the detection result comprises:
when the detection result indicates that the microphone receives a user's audio input, zooming in on the area to generate the first video data; and
when the detection result indicates that the microphone does not receive the user's audio input, generating the first video data without zooming in on the area.

7. The method of claim 1, wherein the step of transmitting the multimedia data comprising the subtitle data from the first data source and at least the part of the first video data from the second data source to the display apparatus is performed during a first period, and the method further comprises:
during a second period adjacent to the first period, receiving second video data from the first data source without receiving any video data from the second data source, and transmitting at least the second video data from the first data source to the display apparatus.

8. The method of claim 1, further comprising:
storing the first video data received from the second data source into a storage medium; and
recording synchronization information of the first video data and the first data source into the storage medium.

9. The method of claim 8, further comprising:
receiving at least the part of first video data from the storage medium;
transmitting at least the part of first video data from the storage medium and the subtitle data from the first data source to the display apparatus; and
utilizing the synchronization information to synchronize at least the part of first video data from the storage medium and the subtitle data from the first data source to make the subtitle data and at least the part of first video data be displayed on the display apparatus at the same time.

10. A multimedia player for generating multimedia data to be displayed on a display apparatus, comprising:
a storage medium reader, for reading subtitle data from a first data source;
an interface, for connecting to a second data source different from the first data source; and
a controller, coupled to the storage medium reader and the interface, for receiving the subtitle data from the first storage medium and first video data from the second data source, and transmitting the multimedia data comprising the subtitle data from the first data source and at least a part of the first video data from the second data source to the display apparatus, wherein the subtitle data and at least the part of first video data are displayed on the display apparatus at the same time.

11. The multimedia player of claim 10, wherein the second data source is a camera, and the camera captures images of a scene to generate the first video data.

12. The multimedia player of claim 11, wherein the controller further determines a background part and a non-background part of the images captured by the camera; and the controller transmits the multimedia data comprising the subtitle data from the first data source and the non-background part of the images from the camera to the display apparatus, wherein the background part of the images from the camera is not transmitted to the display apparatus.

13. The multimedia player of claim 12, wherein the controller further receives background image data different from the background part of the images, and transmits the multimedia data comprising the subtitle data from the first data source, the non-background part of the images from the camera, and the background image data to the display apparatus.

14. The multimedia player of claim 11, wherein the controller detects a specific object in the scene to generate a detection result; and controls the camera to zoom in on an area that includes the specific object to generate the first video data according to the detection result.

15. The multimedia player of claim 14, wherein the specific object is a microphone, and when the detection result indicates that the microphone receives a user's audio input, the controller controls the camera to zoom in on the area to generate the first video data; and when the detection result indicates that the microphone does not receive the user's audio input, the controller controls the camera to generate the first video data without zooming in on the area.

16. The multimedia player of claim 10, wherein the controller transmits the multimedia data comprising the subtitle data from the first data source and at least the part of the first video data from the second data source to the display apparatus during a first period, and during a second period adjacent to the first period, the controller receives second video data from the first data source without receiving any video data from the second data source, and transmits at least the second video data from the first data source to the display apparatus.

17. The multimedia player of claim 10, wherein the controller further stores the first video data received from the second data source into a storage medium, and records synchronization information of the first video data and the first data source into the storage medium.

18. The multimedia player of claim 10, wherein the controller receives at least the part of first video data from the storage medium, and transmits at least the part of first video data from the storage medium and the subtitle data from the first data source to the display apparatus, and utilizes the synchronization information to synchronize at least the part of first video data from the storage medium and the subtitle data from the first data source to make the subtitle data and at least the part of first video data be displayed on the display apparatus at the same time.
